(19) United States
(12) Patent Application Publication
(10) Pub. No.: US 2023/0171287 A1
(43) Pub. Date: Jun. 1, 2023

(54) SYSTEM AND METHOD FOR IDENTIFYING A PHISHING EMAIL

(71) Applicant: AO Kaspersky Lab, Moscow (RU)

(72) Inventors: Yury G Slobodyanuk, Moscow (RU); Roman A. Dedenok, Moscow (RU); Dmitry S. Golubev, Moscow (RU); Nikita D. Benkovich, Moscow (RU); Daniil M. Kovalchuk, Moscow (RU)

(21) Appl. No.: 17/536,281

(22) Filed: Nov. 29, 2021

(51) Int. Cl. H04L 29/06; G06N 3/04

(52) U.S. Cl. CPC H04L 63/1483; G06N 3/0445

(57) ABSTRACT

Disclosed herein are systems and methods for identifying a phishing email message. In one aspect, an exemplary method comprises, identifying an email message as a suspicious email message by applying a first machine learning model, identifying the suspicious email message as a phishing message by applying a second machine learning model, and taking an action to provide information security against the identified phishing message. In one aspect, the first machine learning model is pre-trained on first attributes comprising values of Message_ID header, X-mail headers, or sequences of values of headers. In one aspect, the second machine learning model is pre-trained on second attributes comprising attributes related to at least one of: reputation of links, categories of email messages, flag indicating domains of blocked or known senders, a degree of similarity of the domain with those of known senders, flags indicating HTML code or script in the body of the email.

### FIELD OF TECHNOLOGY

The present disclosure relates to the field of information security, e.g., by blocking phishing email messages.

### BACKGROUND

Phishing refers to a form of illegal activity intended to force a victim to share sensitive information, such as a password or credit card number. Most often, fraudsters try to deceive a user into visiting a fake site and entering their details - login name, password, or a Personal Identification Number (PIN) or code.

In order to induce a victim into visiting a fake site, attackers may use bulk or individually addressed email messages that masquerade as messages sent by a work colleague, a bank employee, or a representative of a government agency. However, these messages contain a malicious link. The text included in the message instructs or requires the victim to click on the link and immediately perform certain actions in order to avoid threats or some kind of serious consequences. Another approach fraudsters employ involves using an attachment in the form of a file that also contains malicious links or exploits vulnerable applications to further compromise the user’s computer.

When the victim clicks on the link, he/she is taken to a phishing site where an invitation is extended to the victim to “log into the system” using his/her account details. Some scammers go even further by asking the victim to send copies of documents or photos establishing their identity. If the victim is sufficiently trusting and agrees, then the data transferred from the victim is sent directly to the attackers - thereby enabling the scammers to use the transferred data to steal confidential information or money.

Fraud detection schemes may be used to order to mitigate against these types of phishing attacks. There are two main types of fraud detection schemes. The first type of fraud detection scheme relates to schemes that detect phishing based on analysis of the contents of target web pages, that is, analysis of the web pages to which the emails are the attached documents are linked. The second type of fraud detection scheme relates to schemes that work directly with the contents of the email messages. While these first and second fraud detection schemes handle the tasks of recognizing targeted mailings that mimic emails from trusted senders, neither type is able to recognize phishing messages from unknown senders. In addition, the identification of a phishing message based on the degree of similarity of domains may discredit a legitimate sender. Instead, it is necessary to take a multi-level approach to reduce the number of attacks and reduce falsely identified phishing messages.

Therefore, there is a need for a method and a system for improving information security while blocking phishing emails.

### SUMMARY

Aspects of the disclosure relate to information security, more specifically, to systems and methods of identifying phishing emails. For example, the method of the present disclosure is designed to block phishing email messages using a multi-level approach - thereby reducing the number of attacks while simultaneously reducing the number of emails falsely identified as phishing emails.

In one exemplary aspect, a method is provided for identifying phishing emails, the method comprising: identifying an email message as a suspicious email message by applying a first machine learning model, identifying the suspicious email message as a phishing message by applying a second machine learning model, and taking an action to provide information security against the identified phishing message.

In one aspect, the method further comprises placing the suspicious email message into a temporary quarantine.

In one aspect, the first machine learning model is pre-trained on first attributes of email messages, the first attributes comprising at least attributes related to: a value of a Message_ID header of the email message; a value of an X-mail email header of the email message; and a sequence of values of headers of the email message.

In one aspect, the second machine learning model is pre-trained on second attributes of email messages, the second attributes comprising attributes related to at least one of: a reputation of a plurality of links which characterizes a probability that an email message contains a phishing link; a category of the email message; a flag indicating a presence of a domain of a sender in a previously created list of blocked senders; a flag indicating a presence of a domain of a sender in a previously created list of known senders; a degree of similarity of a domain of a sender with domains in a previously created list of known senders; a flag indicating a presence of an Hyper-Text Markup Language (HTML) code in a body of the email message; and a flag indicating a presence of a script inserted in a body of the email.

In one aspect, the reputation of the plurality of links is calculated using a recurrent neural network.

In one aspect, a category of the email message indicating whether or not the email message is a phishing message is based on N-grams of text of the email message, the N-grams being identified by selecting one or more important features that strongly influence a binary classification of the phishing email message.

In one aspect, a category of the email message indicating whether or not the email message is a phishing message is based on a logic regression algorithm with regularization, wherein the regularization allows weight coefficients to be determined for N-grams, the weight coefficient of a given N-gram characterizing a degree of influence of the N-gram on a classification of the email message as a phishing message.

In one aspect, the second machine learning model is based on at least one of the following learning algorithms: an algorithm based on a Bayesian classifier; a logistical regression algorithm; a modified random forest training algorithm; a support vector machine; an algorithm using nearest neighbor; and a decision tree based algorithm.

In one aspect, the taking of the action to provide information security against the identified phishing message comprises at least one of: blocking the phishing message; informing a recipient that the email message is a phishing message; and placing an identifier of phishing email in a database storing a list of malicious emails.

According to one aspect of the disclosure, a system is provided for identifying phishing emails, the system comprising a hardware processor configured to: identify an email message as a suspicious email message by applying a first machine learning model, identify the suspicious email message as a phishing message by applying a second machine learning model, and take an action to provide information security against the identified phishing message.

In one exemplary aspect, a non-transitory computer-readable medium is provided storing a set of instructions thereon for identifying phishing emails, wherein the set of instructions comprises instructions for: identifying an email message as a suspicious email message by applying a first machine learning model, identifying the suspicious email message as a phishing message by applying a second machine learning model, and taking an action to provide information security against the identified phishing message.

The method and system of the present disclosure are designed to provide information security, in a more optimal and effective manner, enabling legitimate emails to proceed towards the recipient while blocking phishing emails. Thus, in one aspect, the technical result of the present disclosure includes the identification of a phishing email messages. In another aspect, the technical result includes reducing the number of email messages falsely identified as phishing emails. In yet another aspect, the technical result comprises providing information security by blocking phishing email messages.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a block diagram of an exemplary system for collecting and storing attributes of an email message in accordance with aspects of the present disclosure.

FIG. 2 illustrates a block diagram of an exemplary system used to implement a method for identifying a phishing email message in accordance with aspects of the present disclosure.

FIG. 3 illustrates a method for identifying a phishing email message in accordance with aspects of the present disclosure.

FIG. 4 presents an example of a general purpose computer system on which aspects of the present disclosure can be implemented.

### DETAILED DESCRIPTION

Exemplary aspects are described herein in the context of a system, method, and a computer program for identifying phishing emails in accordance with aspects of the present disclosure. Those of ordinary skill in the art will realize that the following description is illustrative only and is not intended to be in any way limiting. Other aspects will readily suggest themselves to those skilled in the art having the benefit of the disclosure. Reference will now be made in detail to implementations of the example aspects as illustrated in the accompanying drawings. The same reference indicators will be used to the extent possible throughout the drawings and the following description to refer to the same or like items.

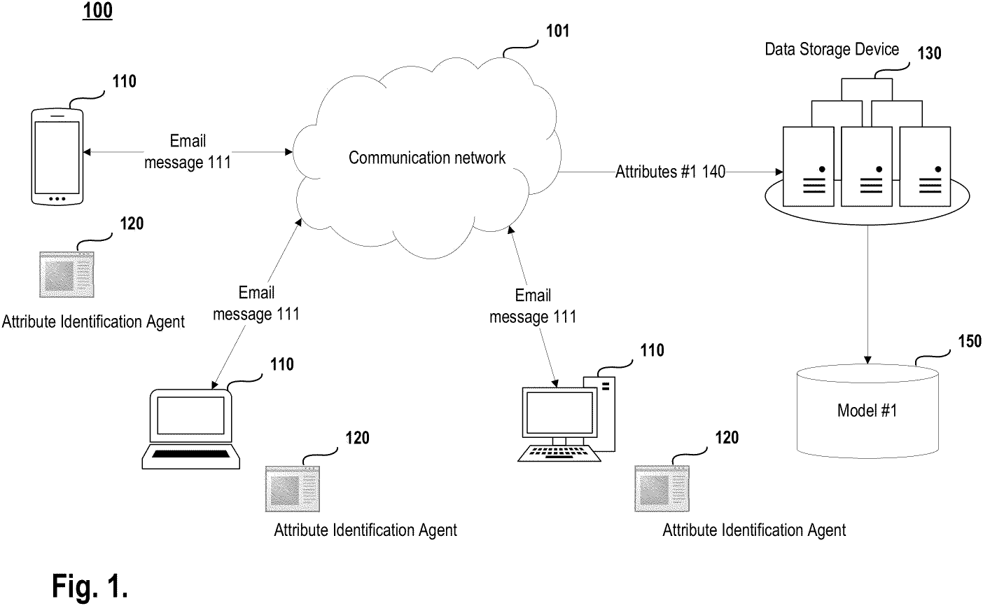

FIG. 1 illustrates a block diagram of an exemplary system 100 for collecting and storing attributes of an email message in accordance with aspects of the present disclosure. In one aspect, the block diagram of the example system for collecting and storing the attributes of an email message contains a communication network 101, a user device 110, an email message 111, #1 attributes 140, an attribute identification agent 120, a data storage device 130, and machine learning model #1 150.

The communication network 101 is a system of physical communication channels that implements an electronic message transfer protocol 111 between the terminal devices, as well as the transfer of #1 attributes 140 to the data storage device 130.

The email message 111 has a specific structure. It contains a body and headers -ancillary information about the route taken by the emails. For example, the headers provide information about when and where the email came from and by which route, as well as information added to the email by various utility programs (mail clients).

In one aspect, the #1 attributes 140 include the values of the headers associated with routing information of the email 111, and ancillary information generated by mail clients

For example, the #1 attributes 140 consist of at least:
Message_ID: a unique identifier of the email message 111, which is assigned by the first mail server that the message meets along its path;
X-mailer (mailer_name): the value of the header field in which the email client or service that was used to create the email message 111 identifies itself; and
the sequence of values of the headers of the email message 111.

In one aspect, the user device 110 contains the mail client and the attribute identification agent 120. Then, using the e-mail client, the user device 110 generates an email message 111 and sends it via the communication network 101, and also receives an email message 111 from other devices.

In one aspect, the attribute identification agent 120 intercepts the email message 111 by at least one of:
tracking the traffic received and transmitted via mail protocols (POP3, SMTP, IMAP, NNTP);
tracking files in the mail server repositories; and
tracking files in the mail client repositories.

In one aspect, the attribute identification agent 120 identifies #1 attributes 140 contained in the intercepted email message 111 and transfers them to the data storage device 130 via the communication network 101.

In one aspect, the data storage device 130 is designed to collect, store, and process the #1 attributes 140. For example, the #1 attributes 140 are used to train the machine learning model #1 stored in database 150.

The storage device 130 is a cloud storage device that handles the #1 attributes 140 in the so-called cloud, where the cloud is a storage model that provides internet-based data storage by means of a cloud computing resource provider that provides and manages data storage as a service. For example, the data storage device 130 may be a tool containing the Kaspersky Security Network (KSN) system from the Kaspersky Lab company.

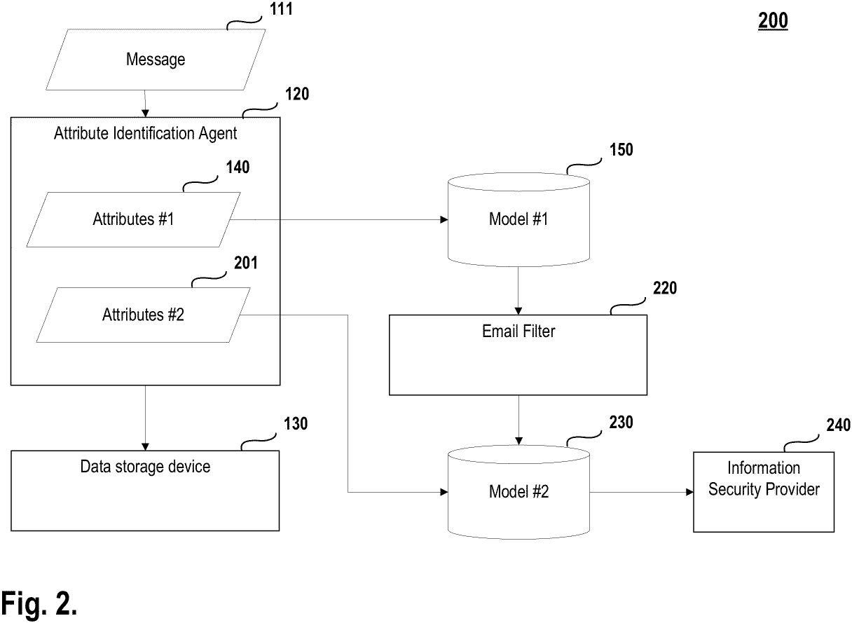

FIG. 2 illustrates a block diagram 200 of an exemplary system used to implement a method for identifying a phishing email message in accordance with aspects of the present disclosure. In one aspect, the block diagram 200 of the system for identifying a phishing email contains an email message 111, an attribute identification agent 120, a data storage device 130, #1 attributes 140, #2 attributes 201, a machine learning model #1 stored in database 150, an email filter 220, a machine learning model #2 stored in database 230, and an information security provider 240.

The attribute identification agent 120 is designed to intercept the email message 111, identify the #1 attributes 140, the #2 attributes 201, and to transfer the #1 attributes 140 to a data storage device 130.

In one aspect, the #1 attributes 140 consist of at least one of:
a value of a Message_ID header of the email message 111;
a value of an X-mailer (mailer_name) header of the email message 111; and
a sequence of values of headers of the email message 111.

The machine learning model #1 stored in database 150 is designed to classify an email message 111 based on the #1 attributes 140. In one aspect, the machine learning model #1 classifies the email message 111 as at least as one of:
suspicious (e.g., containing spam, a malicious attachment, or a phishing link); and
genuine.

In one aspect, the machine learning model #1 stored in database 150 has been pre-trained using the #1 attributes 140 transferred to the data storage device 130, such that the machine learning model #1 stored in database 150 identifies, based on the specified attributes, the features with which an email message 111 is classified with a certain probability.

In one aspect, the machine learning model #1 can be based on deep learning methods. In particular, the #1 attributes 140 are represented as a matrix, where each symbol of a #1 attribute 140 is encoded by a fixed-length vector of numbers, and is transformed using a neural network that calculates the degree of similarity of the specified attributes with the attributes of suspicious messages. The features are formed by the #1 attributes 140 transformed by the neural network layer.

The email filter 220 is designed to place an email message 111, which has been classified as suspicious by machine learning model #1 stored in database 150, into temporary quarantine.

In one aspect, the email filter 220 temporarily quarantines an email 111 that has a higher degree of similarity to a suspicious message than a predefined value (for example, 0.7).

In one aspect, the machine learning model #2 stored in database 230 is designed to classify a suspicious email message based on the #2 attributes 201. The machine learning model #2 classifies a suspicious email message as at least one of:
a phishing email; and
an unknown email.

In one aspect, the #2 attributes 201 consist of at least one of:
a reputation of a plurality of links which characterizes a probability that an email message contains a phishing link;
a category of the email message;
a flag indicating a presence of a domain of a sender in a previously created list of blocked senders;
a flag indicating a presence of a domain of a sender in a previously created list of known senders;
a degree of similarity of a domain of a sender with domains in a previously created list of known senders;
a flag indicating a presence of an Hyper-Text Markup Language (HTML) code in a body of the email message; and
a flag indicating a presence of a script inserted in a body of the email.

In one aspect, the attribute identification agent 120 calculates the reputation of the plurality of links using a recurrent neural network (RNN).

For example, the attribute identification agent 120 encodes the URL address string of the link as a matrix of numbers (in particular, encodes each symbol of the URL as a fixed-length vector), and then passes the encoded string to the recurred neural network. The network extracts structural and semantic features from the URL address, and then uses the activation function to calculate the degree of similarity of the extracted features to corresponding features of phishing URLs. As a result, the reputation of the link consists of the probability that the link URL address will be associated with phishing URLs.

In another aspect, the reputation of a plurality of links consists of a measure of the central trend of the reputations of a plurality of links.

In one aspect, the category of the email message for determining whether or not the email message is a phishing message is based on N-grams of text of the email message, the N-grams being identified by selecting the most important features that most strongly influence a binary classification of a phishing email message.

For example, in phishing email messages, the following trigrams are often encountered: “Account will be blocked”, “you won money”, “change password urgently”, which appeal to the emotions of the recipient.

In another aspect, a phishing message is classified on the basis of a logistic regression algorithm with regularization. For example, the text of a message from a training sample is broken down into N-grams of a predetermined length. These N-grams are used as features for training the classification model of a phishing email message based on a logic regression algorithm with L1-regularization. The use of L1-regularization allows the weight coefficient of each N-gram to be determined, which characterizes the degree of influence of each N-gram on the classification result. N-grams with a weight coefficient greater than a predefined value (for example, greater than 0) are used as the message category.

In one aspect, attributes of email messages belonging to a known class of messages (for example, phishing) are collected in advance. Based on the collected data, the classification machine learning model #2 stored in database 230 is trained in such a way that messages with similar attributes can be classified by the aforementioned machine learning model with an accuracy greater than a specified value.

The classification algorithm consists of at least one of the following algorithms (or a combination of them):
Bayesian classifiers (naive Bayesian classifiers);
logistical regression;
MRF classifier;
support vector machine (SVM);
methods based on nearest neighbors (k-nearest neighbor); and
decision tree.

In one of the embodiments, the system additionally comprises an information security provider 240, which is designed to ensure information security.

In one aspect, the providing of the information security includes at least:
blocking a phishing email message;
informing the recipient of the phishing nature of the email message; and
placing an identifier of the phishing email in a database of malicious email messages.

For example, the information security provider 240 is formed by the security application module supplied by Kaspersky Lab (for example, Kaspersky Internet Security).

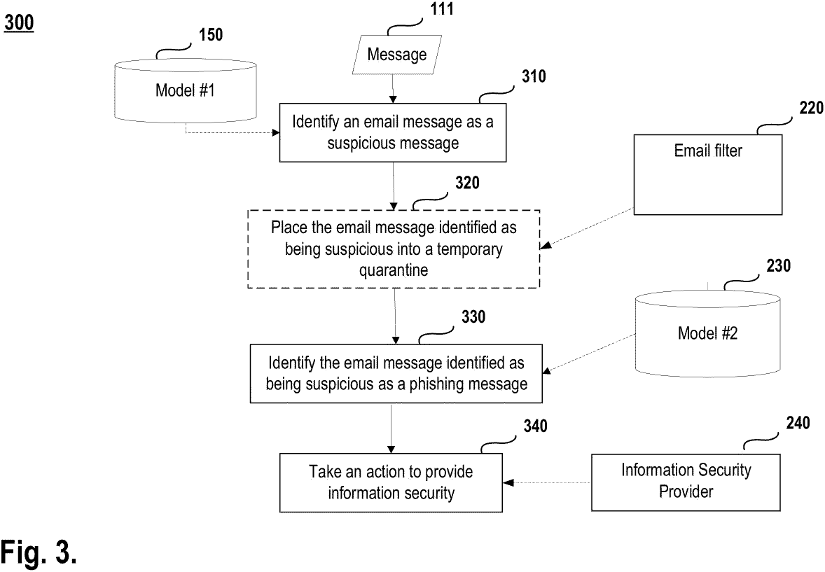

FIG. 3 illustrates a method 300 for identifying a phishing email message in accordance with aspects of the present disclosure. The method 300 comprises a step 310, in which the email is identified as suspicious, a step 320, in which an email identified as suspicious is placed in temporary quarantine, a step 330, in which a phishing email is identified, and a step 340, in which the information security is provided.

In step 310, method 300 identifies an email message as a suspicious email message. The method 300 applies a machine learning model #1 stored in the database 150 to identify emails as being suspicious email messages.

In optional step 320, method 300 places an email message identified as a suspicious email message into a temporary quarantine. For example, the method 300 uses an email filter 220 to filter emails for placing to a temporary quarantine.

In step 330, method 300 identifies the suspicious email message (as identified in step 310) as a phishing message. For example, the method 300 applies a machine learning model #2 stored in database 230 to determine whether or not the suspicious email message is a phishing message.

In step 340, method 300 takes an action to provide information security against the identified phishing message. The action to provide information security is taken using the information security provider 240.

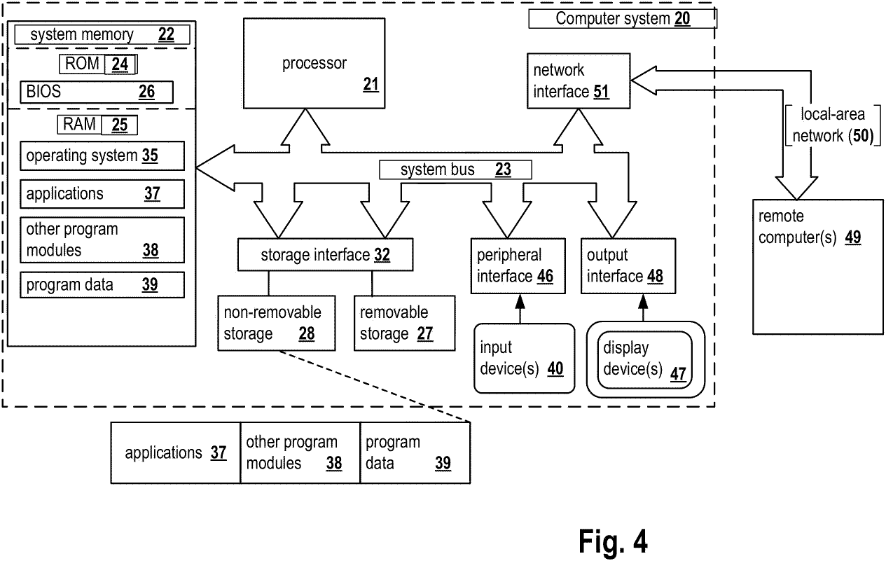

FIG. 4 is a block diagram illustrating a computer system 20 on which aspects of systems and methods for identifying phishing emails may be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module’s functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 4, above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer’s specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for identifying a phishing email message, the method comprising:
identifying an email message as a suspicious email message by applying a first machine learning model;
identifying the suspicious email message as a phishing message by applying a second machine learning model; and
taking an action to provide information security against the identified phishing message.

2. The method of claim 1, further comprising:
placing the suspicious email message into a temporary quarantine.

3. The method of claim 1, wherein the first machine learning model is pre-trained on first attributes of email messages, the first attributes comprising at least attributes related to:
a value of a Message_ID header of the email message;
a value of an X-mail email header of the email message; and
a sequence of values of headers of the email message.

4. The method of claim 1, wherein the second machine learning model is pre-trained on second attributes of email messages, the second attributes comprising attributes related to at least one of:
a reputation of a plurality of links which characterizes a probability that an email message contains a phishing link;
a category of the email message;
a flag indicating a presence of a domain of a sender in a previously created list of blocked senders;
a flag indicating a presence of a domain of a sender in a previously created list of known senders;
a degree of similarity of a domain of a sender with domains in a previously created list of known senders;
a flag indicating a presence of an Hyper-Text Markup Language (HTML) code in a body of the email message; and
a flag indicating a presence of a script inserted in a body of the email.

5. The method of claim 4, wherein the reputation of the plurality of links is calculated using a recurrent neural network.

6. The method of claim 1, wherein a category of the email message indicating whether or not the email message is a phishing message is based on N-grams of text of the email message, the N-grams being identified by selecting one or more important features that strongly influence a binary classification of the phishing email message.

7. The method of claim 1, wherein a category of the email message indicating whether or not the email message is a phishing message is based on a logic regression algorithm with regularization, wherein the regularization allows weight coefficients to be determined for N-grams, the weight coefficient of a given N-gram characterizing a degree of influence of the N-gram on a classification of the email message as a phishing message.

8. The method of claim 1, wherein the second machine learning model is based on at least one of the following learning algorithms:
an algorithm based on a Bayesian classifier;
a logistical regression algorithm;
a modified random forest training algorithm;
a support vector machine;
an algorithm using nearest neighbor; and
a decision tree based algorithm.

9. The method of claim 1, wherein the taking of the action to provide information security against the identified phishing message comprises at least one of:
blocking the phishing message;
informing a recipient that the email message is a phishing message; and
placing an identifier of phishing email in a database storing a list of malicious emails.

10. A system for identifying a phishing email message, comprising:
at least one processor configured to:
identify an email message as a suspicious email message by applying a first machine learning model;
identify the suspicious email message as a phishing message by applying a second machine learning model; and
take an action to provide information security against the identified phishing message.

11. The system of claim 10, the processor further configured to:
place the suspicious email message into a temporary quarantine.

12. The system of claim 10, wherein the first machine learning model is pre-trained on first attributes of email messages, the first attributes comprising at least attributes related to:
a value of a Message_ID header of the email message;
a value of an X-mail email header of the email message; and
a sequence of values of headers of the email message.

13. The system of claim 10, wherein the second machine learning model is pre-trained on second attributes of email messages, the second attributes comprising attributes related to at least one of:
a reputation of a plurality of links which characterizes a probability that an email message contains a phishing link;
a category of the email message;
a flag indicating a presence of a domain of a sender in a previously created list of blocked senders;
a flag indicating a presence of a domain of a sender in a previously created list of known senders;
a degree of similarity of a domain of a sender with domains in a previously created list of known senders;
a flag indicating a presence of an Hyper-Text Markup Language (HTML) code in a body of the email message; and
a flag indicating a presence of a script inserted in a body of the email.

14. The system of claim 13, wherein the reputation of the plurality of links is calculated using a recurrent neural network.

15. The method of claim 10, wherein a category of the email message indicating whether or not the email message is a phishing message is based on N-grams of text of the email message, the N-grams being identified by selecting one or more important features that strongly influence a binary classification of the phishing email message.

16. The system of claim 10, wherein a category of the email message indicating whether or not the email message is a phishing message is based on a logic regression algorithm with regularization, wherein the regularization allows weight coefficients to be determined for N-grams, the weight coefficient of a given N-gram characterizing a degree of influence of the N-gram on a classification of the email message as a phishing message.

17. The system of claim 10, wherein the second machine learning model is based on at least one of the following learning algorithms:
an algorithm based on a Bayesian classifier;
a logistical regression algorithm;
a modified random forest training algorithm;
a support vector machine;
an algorithm using nearest neighbor; and
a decision tree based algorithm.

18. The system of claim 10, wherein the taking of the action to provide information security against the identified phishing message comprises at least one of:
blocking the phishing message;
informing a recipient that the email message is a phishing message; and
placing an identifier of phishing email in a database storing a list of malicious emails.

19. A non-transitory computer readable medium storing thereon computer executable instructions for identifying a phishing email message, including instructions for:
identifying an email message as a suspicious email message by applying a first machine learning model;
identifying the suspicious email message as a phishing message by applying a second machine learning model; and
taking an action to provide information security against the identified phishing message.

20. The non-transitory computer readable medium of claim 19, the instructions further comprising instructions for:
placing the suspicious email message into a temporary quarantine.

21. The non-transitory computer readable medium of claim 19, wherein the first machine learning model is pre-trained on first attributes of email messages, the first attributes comprising at least attributes related to:
a value of a Message_ID header of the email message;
a value of an X-mail email header of the email message; and
a sequence of values of headers of the email message.

22. The non-transitory computer readable medium of claim 19, wherein the second machine learning model is pre-trained on second attributes of email messages, the second attributes comprising attributes related to at least one of:
a reputation of a plurality of links which characterizes a probability that an email message contains a phishing link;
a category of the email message;
a flag indicating a presence of a domain of a sender in a previously created list of blocked senders;
a flag indicating a presence of a domain of a sender in a previously created list of known senders;
a degree of similarity of a domain of a sender with domains in a previously created list of known senders;
a flag indicating a presence of an Hyper-Text Markup Language (HTML) code in a body of the email message; and
a flag indicating a presence of a script inserted in a body of the email.

23. The non-transitory computer readable medium of claim 22, wherein the reputation of the plurality of links is calculated using a recurrent neural network.

24. The non-transitory computer readable medium of claim 19, wherein a category of the email message indicating whether or not the email message is a phishing message is based on N-grams of text of the email message, the N-grams being identified by selecting one or more important features that strongly influence a binary classification of the phishing email message.

25. The non-transitory computer readable medium of claim 19, wherein a category of the email message indicating whether or not the email message is a phishing message is based on a logic regression algorithm with regularization, wherein the regularization allows weight coefficients to be determined for N-grams, the weight coefficient of a given N-gram characterizing a degree of influence of the N-gram on a classification of the email message as a phishing message.

26. The non-transitory computer readable medium of claim 19, wherein the second machine learning model is based on at least one of the following learning algorithms:
an algorithm based on a Bayesian classifier;
a logistical regression algorithm;
a modified random forest training algorithm;
a support vector machine;
an algorithm using nearest neighbor; and
a decision tree based algorithm.

27. The non-transitory computer readable medium of claim 19, wherein the taking of the action to provide information security against the identified phishing message comprises at least one of:
blocking the phishing message;
informing a recipient that the email message is a phishing message; and
placing an identifier of phishing email in a database storing a list of malicious emails.
